(19) United States
(12) Patent Application Publication
(10) Pub. No.: US 2026/0160627 A1
(43) Pub. Date: Jun. 11, 2026

(54) ELECTRONIC COMPONENT WITH COVER, METHOD FOR MANUFACTURING ELECTRONIC COMPONENT WITH COVER, AND PRESSURE SENSOR SEALING STRUCTURE

(71) Applicant: Proterial, Ltd., Tokyo (JP)

(72) Inventors: Takumi KOBAYASHI, Tokyo (JP); Kanako SUGANUMA, Tokyo (JP)

(73) Assignee: Proterial, Ltd., Tokyo (JP)

(21) Appl. No.: 19/402,613

(22) Filed: Nov. 26, 2025

(30) Foreign Application Priority Data
Dec. 9, 2024 (JP) 2024-214696

(51) Int. Cl. G01L 19/06; G01L 9/00

(52) U.S. Cl. CPC G01L 19/0627; G01L 9/0041

(57) ABSTRACT

An electronic component with cover includes an electric wire, an electronic component including an electrode connected to the electric wire, and a cover member that covers the electronic component together with a portion of the electric wire, wherein the cover member has a tubular shape, and wherein an adhesive fills a space between an inner surface of the cover member and the electronic component.

### CROSS-REFERENCE TO RELATED APPLICATIONS

The present application claims the benefit of Japanese patent application No. 2024-214696 filed on Dec. 9, 2024, the entire contents of which are incorporated herein by reference.

### TECHNICAL FIELD

The present invention relates to an electronic component with cover, a method for manufacturing an electronic component with cover, and a pressure sensor sealing structure.

### BACKGROUND OF THE INVENTION

Some of conventional endoscopes to be inserted into the human body have pressure sensors arranged at their tips. The endoscope described in Patent literature 1 is configured such that an observation window is provided so as to correspond to an imaging element of a CCD (Charge Coupled Device) image sensor, etc., and plural pressure sensors are arranged at the tip of an insertion portion to be inserted into hollow organs such as the digestive tract. The pressure sensors are fixed to the tip of the insertion portion by means of an adhesive or a sticky material, and output signals to signal lines, which indicate pressure caused by contact with the intestinal wall, etc. inside the body.

Citation List Patent Literature 1: JP2021-141973A

### SUMMARY OF THE INVENTION

Endoscopes configured as described in Patent Literature 1 may exhibit electrostatic failure in the pressure sensors if sufficient care is not taken during assembly, etc. In addition, from a biocompatibility perspective, it is desirable to fully cover the pressure sensors with a resin such as silicone. However, when, e.g., a liquid silicone resin is applied and cured to the pressure sensors, the corners, etc., of the pressure sensors tend to be exposed due to surface tension in the liquid state; hence, it is difficult to reliably and completely cover the pressure sensors.

Therefore, it is an object of the invention to provide an electronic component with a cover in which an electronic component, such as a pressure sensor, can be reliably entirely covered and protected, a manufacturing method thereof, and a pressure sensor sealing structure.

To solve the above-mentioned problem, the invention provides an electronic component with cover, comprising:
an electric wire;
an electronic component comprising an electrode connected to the electric wire; and
a cover member that covers the electronic component together with a portion of the electric wire,
wherein the cover member has a tubular shape, and
wherein an adhesive fills a space between an inner surface of the cover member and the electronic component.

To solve the above-mentioned problem, the invention also provides a method for manufacturing an electronic component with cover that comprises an electric wire, an electronic component comprising an electrode connected to the electric wire, and a tubular cover member that covers the electronic component together with a portion of the electric wire, the method comprising:
connecting the electric wire to the electrode;
housing the electronic component in the cover member; and
adhering and fixing the electronic component to the cover member with an adhesive by injecting the adhesive into the cover member.

To solve the above-mentioned problem, the invention also provides a pressure sensor sealing structure to seal a pressure sensor that comprises a diaphragm that deforms under pressure, and an electrode connected to an electric wire,
wherein the pressure sensor is housed in a tubular cover member comprising a flexible resin, and
wherein an adhesive fills a space between an inner surface of the cover member and the pressure sensor.

### Advantageous Effects of the Invention

According to the invention, it is possible to provide an electronic component with cover in which an electronic component, such as a pressure sensor, can be reliably and completely covered and protected, a manufacturing method thereof, and a pressure sensor sealing structure.

### BRIEF DESCRIPTION OF DRAWINGS

FIG. 1A is an end view showing a tip of an endoscope incorporating an electronic component with cover in the present embodiment.

FIG. 1B is a cross-sectional view taken along line A-A in FIG. 1A.

FIG. 1C is an external view showing the electronic component with cover.

FIG. 2A is a perspective view showing a pressure sensor.

FIG. 2B is a perspective view showing the pressure sensor when viewed from the opposite direction to FIG. 2A.

FIG. 3 is an explanatory diagram illustrating a state in which electric wires are connected to electrodes of the pressure sensor.

FIG. 4 is an explanatory diagram illustrating a state in which the plural electrodes of the pressure sensor and longitudinal portions of the electric wires are sealed with a first adhesive that serves as a sealing material.

FIG. 5 is an explanatory diagram illustrating a state in which a sensor assembly and a cover member are placed side by side.

FIG. 6 is an explanatory diagram illustrating a state in which a longitudinal portion of the pressure sensor, including a diaphragm, is housed inside the cover member.

FIG. 7 is an explanatory diagram illustrating a state in which the pressure sensor is housed inside the cover member.

FIG. 8A is a configuration diagram illustrating the electronic component with cover as viewed in an axial direction of the cover member, where a second adhesive, which fills the inside of the cover member, is shown together with the assembly.

FIG. 8B is a cross-sectional view taken along line B-B in FIG. 8A.

FIG. 9 is a configuration diagram illustrating the pressure sensor sealed by a conventional sealing structure.

FIGS. 10A and 10B are diagrams illustrating an electronic component with cover in a modification of the embodiment.

### DETAILED DESCRIPTION OF THE INVENTION

### Embodiment

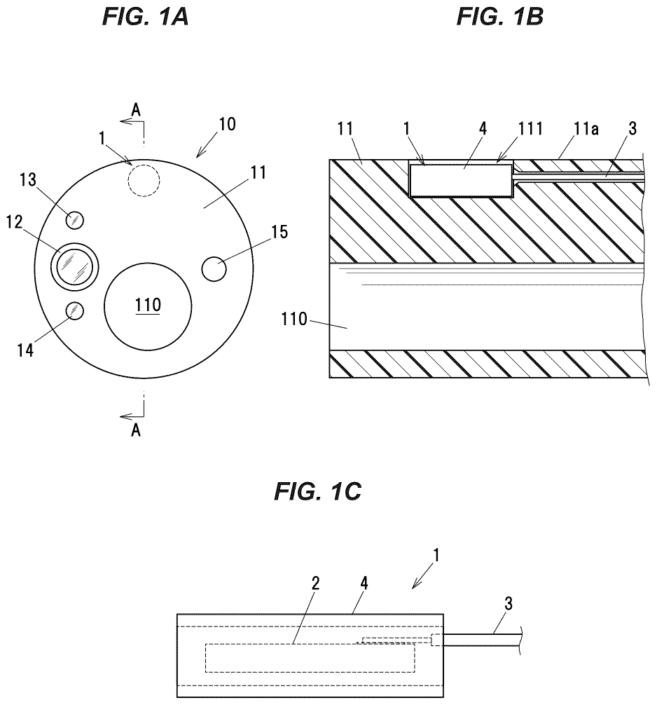

FIG. 1A is an end view showing a tip of an endoscope 10 incorporating an electronic component with cover 1 in the present embodiment. The endoscope 10 is inserted into the human body and used to image the inside of hollow organs. FIG. 1B is a cross-sectional view showing the endoscope 10 taken along line A-A in FIG. 1A. FIG. 1C is an external view showing the electronic component with cover 1. In FIG. 1C, the internal structure of the electronic component with cover 1 is indicated by dashed lines.

The endoscope 10 has a resin tubular body 11 on which the electronic component with cover 1, a CCD (Charge Coupled Device) camera 12, LEDs 13 and 14 for illumination, and a temperature sensor 15 are held. In addition, a flow path 110 to flow a liquid such as physiological saline is formed in the tubular body 11. The electronic component with cover 1 is held in a recessed portion 111 that is open on an outer circumferential surface 11a of the tubular body 11. In the present embodiment, the electronic component with cover 1 is configured as a pressure detection unit to detect pressure. The pressure detection results from the electronic component with cover 1 are used to monitor so that, e.g., pressure around the tip of the endoscope 10 produced by delivering physiological saline from the flow path 110 does not become excessive.

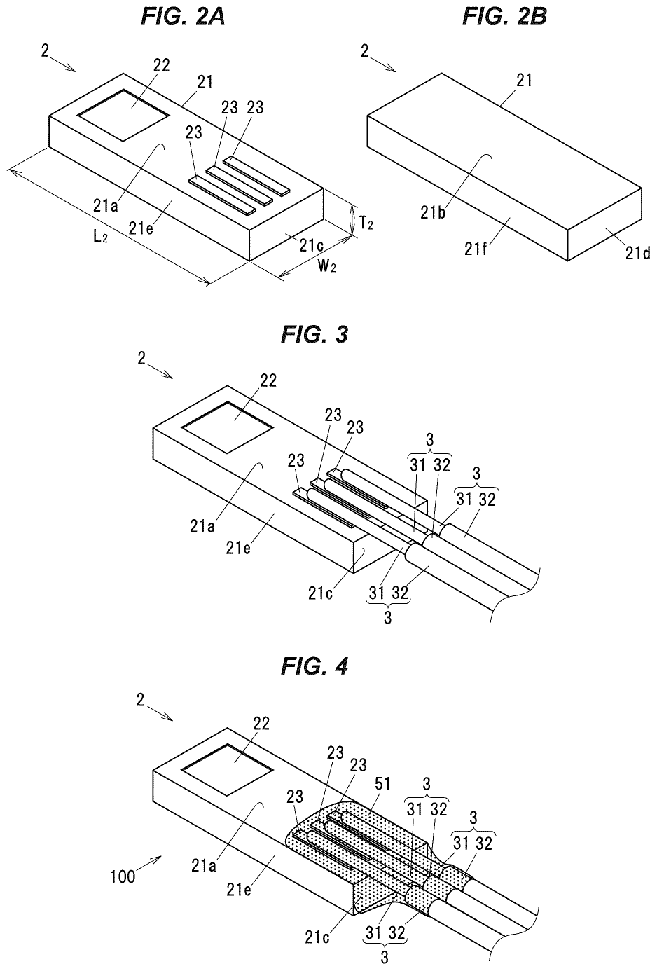

The electronic component with cover 1 has a pressure sensor 2 as an electronic component, electric wires 3 connected to the pressure sensor 2, and a cover member 4 that covers the pressure sensor 2 and portions of the electric wires 3. Next, a configuration of the electronic component with cover 1, its manufacturing method, and a sealing structure for the pressure sensor 2 will be described with reference to FIGS. 2A to 8B.

FIG. 2A is a perspective view showing the pressure sensor 2. FIG. 2B is a perspective view showing the pressure sensor 2 as viewed from the opposite direction to FIG. 2A. The pressure sensor 2 has a base 21 having a rectangular parallelepiped shape, and a diaphragm 22 and plural electrodes 23 that are provided on the base 21. The base 21 has an upper surface 21a and a lower surface 21b, a pair of end surfaces 21c and 21d perpendicular to a longitudinal direction of the base 21, and a pair of side surfaces 21e and 21f perpendicular to a lateral direction of the base 21. The diaphragm 22 is formed on the upper surface 21a near one end in the longitudinal direction of the base 21, and the plural electrodes 23 are formed on the upper surface 21a near the other end in the longitudinal direction of the base 21. The pressure sensor 2 has a length L₂ of, e.g., 0.9 mm, a width W₂ of, e.g., 0.33 mm, and a thickness T₂ of, e.g., 0.12 mm.

The pressure sensor 2 detects pressure based on the amount of deformation of the diaphragm 22 that deforms under pressure. Various known methods (e.g., piezoresistive method, capacitive method, optical method) can be used to detect the amount of deformation of the diaphragm 22. In the present embodiment, the pressure sensor 2 has three electrodes 23, two of which are used to supply power to the pressure sensor 2 while the remaining one is used to output a detection signal indicating a pressure detection result.

FIG. 3 shows a state in which the electric wires 3 are respectively connected to the three electrodes 23 of the pressure sensor 2. The electric wire 3 is an insulation-covered wire in which a core wire 31 made of a conductive material is covered with an insulating cover 32 made of an insulating material. The core wire 31 is electrically connected to the electrode 23 by, e.g., soldering, welding, or a conductive adhesive.

FIG. 4 shows a state in which the plural electrodes 23 of the pressure sensor 2 and portions of the electric wires 3 are sealed with a first adhesive 51 that serves as a sealing material. The first adhesive 51 covers the upper surface 21a of the base 21 around the portion where the plural electrodes 23 are formed, together with a portion of one end surface 21c of the base 21. The first adhesive 51 also entirely covers the exposed longitudinal portions of the core wires 31 located out of the insulating covers 32, as well as partially covers the insulating covers 32.

The first adhesive 51 is, e.g., a cyanoacrylate-based adhesive made mainly of cyanoacrylate, exhibits high strength, and has electrical insulation properties and quick-setting properties. By covering the plural electrodes 23 and portions of the electric wires 3 with the first adhesive 51, it is possible to prevent, e.g., an electrical short-circuit between adjacent electrodes 23 due to adhesion of conductive foreign matters, or separation of the core wires 31 from the electrodes 23 when the electric wires 3 are pulled. Hereinafter, the pressure sensor 2 and the plural electric wires 3 which are partially covered with the first adhesive 51 will be referred to as a sensor assembly 100.

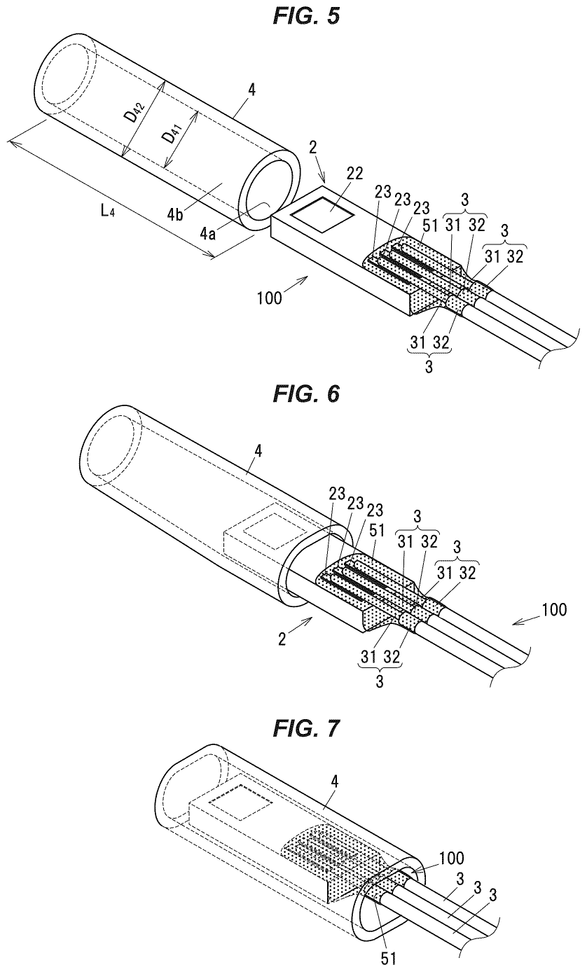

FIG. 5 shows a state in which the sensor assembly 100 and the cover member 4 are placed side by side. The cover member 4 is made of a flexible resin and has a tubular shape. An axial length L₄ of the cover member 4 is longer than the length L₂ of the pressure sensor 2 and is, e.g., 1.1 mm. An inner diameter D₄₁ of the cover member 4 is smaller than the width W₂ of the pressure sensor 2 and is, e.g., 0.30 mm. An outer diameter D₄₂ of the cover member 4 is, e.g., 0.40 mm.

FIG. 6 shows a state in which a longitudinal portion of the pressure sensor 2 including the diaphragm 22 is housed inside the cover member 4. The cover member 4 deforms at a portion housing the pressure sensor 2 so as to be stretched in the width direction of the pressure sensor 2.

FIG. 7 shows a state in which the entire pressure sensor 2 is housed inside the cover member 4. In this state, gaps are formed between the upper surface 21a and the lower surface 21b of the base 21, and the inner surface 4a of the cover member 4. The gaps are filled with a second adhesive described below.

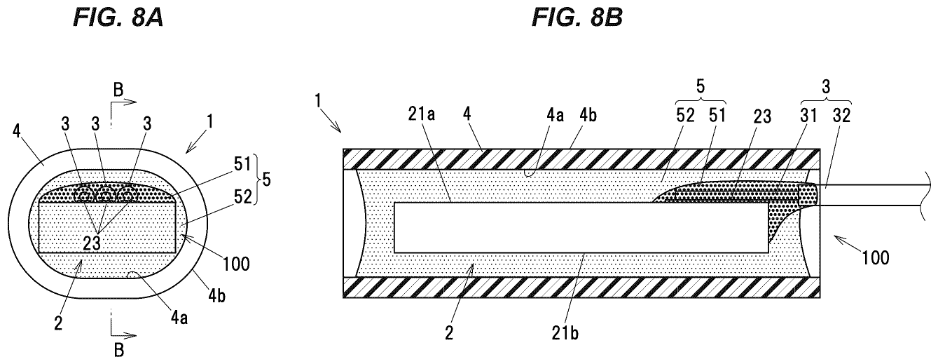

FIG. 8A is a configuration diagram illustrating the electronic component with cover 1 as viewed in the axial direction of the cover member 4, where a second adhesive 52 which fills the inside of the cover member 4 is shown together with the sensor assembly 100. FIG. 8B is a cross-sectional view taken along line B-B in FIG. 8A. In FIGS. 8A and 8A, the first adhesive 51 is shown in dark gray and the second adhesive 52 is shown in light gray. The second adhesive 52 fills a space between the first adhesive 51 and the pressure sensor 2, and the inner surface 4a of the cover member 4.

Hereinafter, the first adhesive 51 and the second adhesive 52 are collectively referred to as adhesive 5. The adhesive 5 fills a space between the inner surface 4a of the cover member 4 and the pressure sensor 2, and the entire pressure sensor 2 is covered with the adhesive 5. An end portion of the insulating cover 32 of each electric wire 3 on the electrode 23 side is covered with the adhesive 5 inside the cover member 4. The pressure sensor 2 is sealed by a sealing structure in which the adhesive 5 filles between the inner surface 4a of the cover member 4 and the pressure sensor 2.

The second adhesive 52 is, e.g., a silicone-based adhesive and has a lower hardness than the first adhesive 51. The first adhesive 51 has a Shore D hardness of, e.g., 80, and the second adhesive 52 has a Shore A hardness of, e.g., 20. The cover member 4 is flexible to the extent that pressure applied to the outer surface 4b thereof can be transmitted to the diaphragm 22 of the pressure sensor 2 through the second adhesive 52.

In the present embodiment, the cover member 4 is made of a silicone rubber. Similar to the second adhesive 52, the cover member 4 also has a lower hardness than the first adhesive 51 and has a Shore A hardness of, e.g., 40. In addition, in the present embodiment, since both the cover member 4 and the second adhesive 52 are silicone-based, adhesion of the second adhesive 52 to the cover member 4 is good.

Next, a method for manufacturing the electronic component with cover 1 will be described. The method for manufacturing the electronic component with cover 1 in the present embodiment includes a connecting step of connecting the plural electric wires 3 respectively to the plural electrodes 23 of the pressure sensor 2 (see FIG. 3), a sealing step of sealing the plural electrodes 23, together with portions of the electric wires 3, with the first adhesive 51 as a sealing material (see FIG. 4), a housing step of housing the pressure sensor 2 in the cover member 4 (see FIGS. 6 and 7), and an adhering step of fixing the pressure sensor 2 to the cover member 4 with the second adhesive 52 by injecting the second adhesive 52 into the cover member 4 (see FIG. 8).

In the adhering step, the sensor assembly 100 is adhered to the cover member 4 with the second adhesive 52. The second adhesive 52 in a liquid state before curing is injected from the end of the cover member 4 opposite to the electric wires 3. At this time, the liquid second adhesive 52 injected into the end portion of the cover member 4 spreads between the sensor assembly 100 and the inner surface 4a of the cover member 4 due to capillary action. The second adhesive 52 is a time-curing adhesive in the present embodiment, but is not limited thereto and may be thermosetting or UV setting.

### Conventional Example

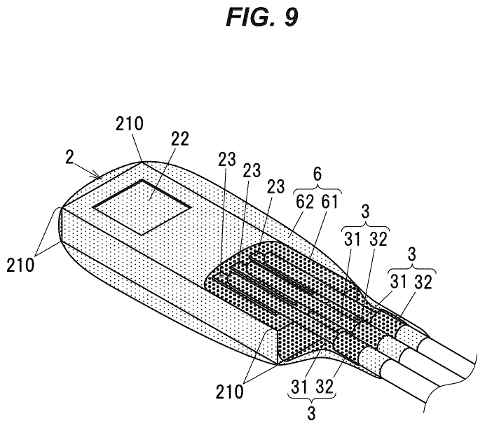

FIG. 9 is a configuration diagram illustrating the pressure sensor 2 sealed by a conventional sealing structure. This sealing structure is a structure in which the pressure sensor 2, together with the plural electric wires 3 connected to the plural electrodes 23, is sealed with an adhesive 6. The adhesive 6 includes a first adhesive 61 that covers the plural electrodes 23 together with portions of the electric wires 3, and a second adhesive 62 that covers the first adhesive 61 and the pressure sensor 2. The first adhesive 61 is a cyanoacrylate-based adhesive in the same manner as the first adhesive 51 in the above embodiment, and the second adhesive 62 is a silicone-based adhesive in the same manner as the second adhesive 52 in the above embodiment.

In such a sealing structure, the pressure sensor 2 can be substantially entirely covered with the adhesive 6, but the thickness of the second adhesive 62 tends to be thin around corners 210 of the rectangular parallelepiped-shaped base 21. This is because due to the surface tension of the second adhesive 62 in a liquid state before curing, the second adhesive 62 adhered to each surface of the base 21 forms a dome shape which is thick at the center of each surface. In addition, the corners 210 may be exposed depending on the amount or viscosity of the second adhesive 62. Therefore, to reliably cover the corners 210, it is necessary to, e.g., further apply a third adhesive to the outside of the second adhesive layer 62.

In contrast to this, in the above embodiment, since the entire pressure sensor 2 is covered with the cover member 4 and the adhesive 5 (the first adhesive 51 and the second adhesive 52) is further applied to fill the space between the inner surface 4a of the cover member 4 and the pressure sensor 2, the entire pressure sensor 2 can be reliably covered with the cover member 4 and the adhesive 5, and the pressure sensor 2 can be reliably protected from foreign matters or electrostatic damage.

### Modification

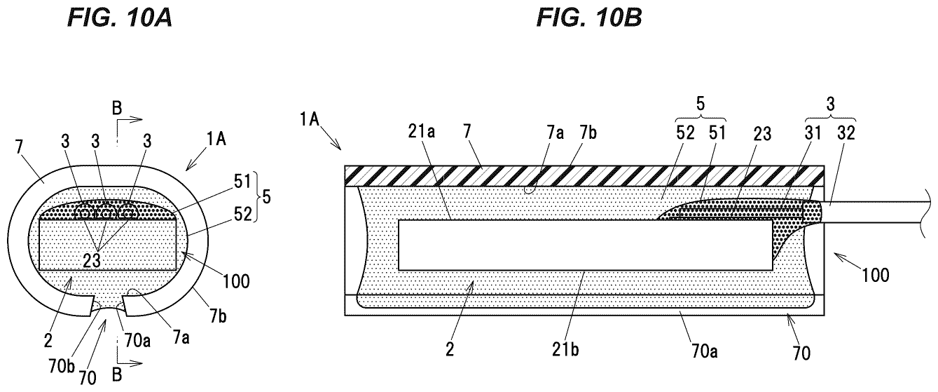

FIGS. 10A and 10B are diagrams illustrating an electronic component with cover 1A in a modification of the embodiment. This electronic component with cover 1A has the pressure sensor 2 and the plural electric wires 3 respectively connected to the plural electrodes 23 of the pressure sensor 2 in the same manner as the electronic component with cover 1 in the above embodiment, but a cover member 7 housing the pressure sensor 2 has a different configuration from the cover member 4 in the above embodiment. FIG. 10A is a configuration diagram illustrating the electronic component with cover 1A as viewed in the axial direction of the cover member 7, and FIG. 10B is a cross-sectional view taken along line B-B in FIG. 10A.

The cover member 7 has a tubular shape in a similar manner to the cover member 4 in the above embodiment, but a slit 70 extending in the axial direction is formed at one location in the circumferential direction of the cover member 7. The adhesive 5 fills a space between an inner surface 7a of the cover member 7 and the pressure sensor 2. The adhesive 5 includes the first adhesive 51 and the second adhesive 52 in the same manner as the above embodiment, and the materials and hardnesses of the first adhesive 51 and the second adhesive 52 are also the same as those in the above embodiment.

The cover member 7 is made of a silicone rubber and has a Shore A hardness of, e.g., 40. The slit 70 is formed linearly over the entire length of the cover member 7 at a portion on a side where the lower surface 21b of the base 21 of the pressure sensor 2 is located. When housing the pressure sensor 2 inside the cover member 7, the slit 70 opens in the circumferential direction of the cover member 7, and the distance between a pair of slit surfaces 70a and 70b, which are the inner surfaces of the slit 70, increases.

The electronic component with cover 1A is manufactured by a manufacturing method including the connecting step, the sealing step, the housing step, and the adhering step, in the same manner as the above embodiment. However, in the adhering step, the second adhesive 52 in a liquid state before curing can be injected from the slit 70 in this modification while the second adhesive 52 in a liquid state before curing is injected from the end of the cover member 4 in the above embodiment. This allows the second adhesive 52 to be injected into the interior of the cover member 7 more efficiently and in a shorter time than the above embodiment.

Also in this modification, since the entire pressure sensor 2 is covered with the cover member 7 and the adhesive 5 (the first adhesive 51 and the second adhesive 52) is further applied to fill the space between the inner surface 7a of the cover member 7 and the pressure sensor 2, the entire pressure sensor 2 can be reliably covered with the cover member 7 and the adhesive 5, and the pressure sensor 2 can be reliably protected from foreign matters or electrostatic damage.

### Summary of the Embodiment

Technical ideas understood from the embodiment will be described below citing the reference signs, etc. used for the embodiment. However, each reference sign described below is not intended to limit the constituent elements in the claims to the members, etc., specifically described in the embodiment.

According to the first feature, an electronic component with cover 1, 1A comprises: an electric wire 3; an electronic component (pressure sensor 2) comprising an electrode 23 connected to the electric wire 3; and a cover member 4, 7 that covers the electronic component 2 together with a portion of the electric wire 3, wherein the cover member 4, 7 has a tubular shape, and wherein an adhesive 5 fills a space between an inner surface 4a, 7a of the cover member 4, 7 and the electronic component 2.

According to the second feature, in the electronic component with cover 1, 1A as described in the first feature, the electric wire 3 comprises an insulation-covered wire in which a core wire 31 comprising a conductive material is covered with an insulating cover 32 comprising an insulating material, the core wire 31 exposed from the insulating cover 32 is connected to the electrode 23, and an end portion of the insulating cover 32 on the electrode 23 side is covered with the adhesive 5.

According to the third feature, in the electronic component with cover 1, 1A as described in the second feature, the adhesive 5 comprises a first adhesive 51 covering the electrode 23 together with the core wire 31 connected to the electrode 23, and a second adhesive 52 filling a space between the first adhesive 51 and the electronic component 2, and the inner surface 4a, 7a of the cover member 4, 7.

According to the fourth feature, in the electronic component with cover 1A as described in the first feature, the cover member 7 comprises a slit 70 extending in an axial direction.

According to the fifth feature, in the electronic component with cover 1, 1A as described in any one of the first to fourth features, the electronic component comprises a pressure sensor 2, and the cover member 4, 7 comprises a flexible resin.

According to the sixth feature, a method for manufacturing an electronic component with cover 1, 1A that comprises an electric wire 3, an electronic component 2 comprising an electrode 23 connected to the electric wire 3, and a tubular cover member 4, 7 that covers the electronic component 2 together with a portion of the electric wire 3, the method comprising: connecting the electric wire 3 to the electrode 23; housing the electronic component 2 in the cover member 4, 7; and adhering and fixing the electronic component 2 to the cover member 4,7 with an adhesive 52 by injecting the adhesive 52 into the cover member 4, 7.

According to the seventh feature, in the method as described in the sixth feature, sealing the electrode 23, together with a portion of the electric wire 3, with a sealing material (first adhesive) 51 is included between the connecting and the housing.

According to the eighth feature, a pressure sensor sealing structure is to seal a pressure sensor 2 that comprises a diaphragm 22 that deforms under pressure, and an electrode 23 connected to an electric wire 3, wherein the pressure sensor 2 is housed in a tubular cover member 4, 7 comprising a flexible resin, and wherein an adhesive 5 fills a space between an inner surface 4a, 7a of the cover member 4, 7 and the pressure sensor 2.

According to the ninth feature, in the pressure sensor sealing structure as described in the eighth feature, the adhesive 5 comprises a first adhesive 51 covering the electrode 23 together with a portion of the electric wire 3 connected to the electrode 23, and a second adhesive 52 filling a space between the first adhesive 51 and the electronic component 2, and the inner surface 4a, 7a of the cover member 4, 7, and the second adhesive 52 has a lower hardness than the first adhesive 51.

Although the embodiment and the modification of the invention have been described, the invention according to claims is not to be limited to the embodiment and the modification described above. Further, please note that not all combinations of the features described in the embodiment are necessary to solve the problem of the invention.

In addition, the invention can be appropriately modified and implemented without departing the gist thereof. For example, although the example in which the pressure sensor 2 is used as the electronic component has been described in the above embodiment, it is not limited thereto. A sensor detecting a physical quantity other than pressure (e.g., temperature, magnetic field, vibration, radiation dose, etc.) or an electronic component other than sensor can be used as the electronic component in the invention. In addition, although the example in which the electronic component with cover 1 is applied to the endoscope 10 has been described in the above embodiment, the electronic component with cover 1 of the invention can be used not only in endoscopes but also in various other devices.

In addition, although the example in which both the cover member 4 and the second adhesive 52 include silicone as the main component has been described in the above embodiment, the main components of the cover member 4 and the second adhesive 52 may be different.

1. An electronic component with cover, comprising:
an electric wire;
an electronic component comprising an electrode connected to the electric wire; and
a cover member that covers the electronic component together with a portion of the electric wire,
wherein the cover member has a tubular shape, and
wherein an adhesive fills a space between an inner surface of the cover member and the electronic component.

2. The electronic component with cover according to claim 1, wherein the electric wire comprises an insulation-covered wire in which a core wire comprising a conductive material is covered with an insulating cover comprising an insulating material, wherein the core wire exposed from the insulating cover is connected to the electrode, and wherein an end portion of the insulating cover on an electrode side is covered with the adhesive.

3. The electronic component with cover according to claim 2, wherein the adhesive comprises a first adhesive covering the electrode together with the core wire connected to the electrode, and a second adhesive filling a space between the first adhesive and the electronic component, and the inner surface of the cover member.

4. The electronic component with cover according to claim 1, wherein the cover member comprises a slit extending in an axial direction.

5. The electronic component with cover according to claim 1, wherein the electronic component comprises a pressure sensor, and wherein the cover member comprises a flexible resin.

6. A method for manufacturing an electronic component with cover that comprises an electric wire, an electronic component comprising an electrode connected to the electric wire, and a tubular cover member that covers the electronic component together with a portion of the electric wire, the method comprising:
connecting the electric wire to the electrode;
housing the electronic component in the cover member; and
adhering and fixing the electronic component to the cover member with an adhesive by injecting the adhesive into the cover member.

7. The method according to claim 6, wherein sealing the electrode, together with a portion of the electric wire, with a sealing material is included between the connecting and the housing.

8. A pressure sensor sealing structure to seal a pressure sensor that comprises a diaphragm that deforms under pressure, and an electrode connected to an electric wire,
wherein the pressure sensor is housed in a tubular cover member comprising a flexible resin, and
wherein an adhesive fills a space between an inner surface of the cover member and the pressure sensor.

9. The pressure sensor sealing structure according to claim 8, wherein the adhesive comprises a first adhesive covering the electrode together with a portion of the electric wire connected to the electrode, and a second adhesive filling a space between the first adhesive and the electronic component, and the inner surface of the cover member, and wherein the second adhesive has a lower hardness than the first adhesive.
